(19) United States
(12) Patent Application Publication
(10) Pub. No.: US 2026/0291817 A1
(43) Pub. Date: Sep. 24, 2026

(54) COST-EFFICIENT JOINT VIRTUAL NETWORK FUNCTION (VNF) DECOMPOSITION AND MIGRATION

(71) Applicant: Telefonaktiebolaget LM Ericsson (publ), Stockholm (SE)

(72) Inventors: Wubin LI, Kirkland (CA); Carla MOURADIAN, Montreal (CA); Róbert SZABÓ, Budapest (HU); Seyedeh Negar AFRASIABI, Montreal (CA); Amin EBRAHIMZADEH, La Salle (CA); Roch GLITHO, Saint Laurent (CA)

(73) Assignee: Telefonaktiebolaget LM Ericsson (publ), Stockholm (SE)

(21) Appl. No.: 19/477,778

(22) PCT Filed: Apr. 27, 2023
(86) PCT No.: PCT/IB2023/054386

§ 371 Date: Oct. 22, 2025

(51) Int. Cl. H04L 41/122; H04L 41/0897; H04L 41/14

(52) U.S. Cl. CPC H04L 41/122; H04L 41/0897; H04L 41/145

(57) ABSTRACT

The disclosure relates to a method and apparatus for embedding a network service (NS) in a network comprising a plurality of nodes. The method comprises executing a first topological decomposition of the NS considering the network when loaded. The method comprises executing a second topological decomposition of the NS considering the network when unloaded. The method comprises migrating at least one existing virtual network function (VNF) that can be reused for the NS to another node of the network upon determination, based on comparing the first and second topological decompositions, that the at least one VNF needs to be migrated. The method comprises embedding each virtual network function (VNF) of the NS within the plurality of nodes of the network.

### TECHNICAL FIELD

The present disclosure relates to cost-efficient joint Virtual Network Function (VNF) decomposition and migration.

### BACKGROUND

Network Function Virtualization (NFV) is a network architecture that separates network functions from dedicated hardware, implementing them as software modules known as virtual network functions, which are executed in virtual machines or containers. NFV allows application components, also called Network Service (NS), to be implemented as sets of VNFs chained in a specific order, represented by VNF-Forwarding Graphs (VNF-FG).

Forming a VNF-FG is challenging, as each VNF may be associated with multiple realizations, commonly referred to as decomposition options. Each decomposition option may comprise one or multiple subfunctions. The order of VNFs for forming a VNF-FG is often flexible since a VNF may be decomposed into multiple subfunctions and have multiple VNF decomposition options.

VNF decomposition refers to the translation of high-level/abstract VNF (e.g., firewall) to more refined VNFs (e.g., an OpenFlow- or an iptables-based Firewall) or decomposing a VNF into multiple VNFs/subfunctions. The decomposition of VNFs required by a network service to form the VNF-FG must be carried out properly based on Service Provider's (SP) objectives. The VNF decomposition problem is also referred to as a topological decomposition problem, which is often viewed as a combinatorial optimization problem.

NFV allows for a VNF instance to be shared among different NSs. More specifically, instead of instantiating new VNF instances, NSs can reuse the already instantiated VNF instances to reduce the embedding cost. Herein, the word “embedding” is defined as the mapping of virtual resources (i.e., VNFs) to physical resources (i.e., substrate nodes/links). The mapping defines the location of the VNF instances in the network and can include the instantiation of new virtual resources or the reusing of already instantiated virtual resources.

Each VNF/subfunction can re-use the same type of VNF/sub-function, which has been instantiated in the substrate network. Therefore, the resources used by sub-functions of different VNF-FGs can be shared, thus leading to efficient allocation of resources and reduction of embedding cost. The selection of a decomposition option of each VNF in the given VNF-FG needs to be carried out such that the SP's objectives are met. However, the resource limitation of the nodes makes it challenging to select the (near) optimal decomposition option among all possible decomposition options.

Improper selection of VNF decomposition options may degrade the QoS. On the other hand, selecting the proper decomposition options may require some VNFs to be moved from one node to another. This is usually done via VNF migration, which has increasingly been adopted to achieve seamless movement of online services executed by VNFs from one physical node to another to achieve better performance. However, stringent latency requirements between VNFs of a given VNF-FG can make those VNFs coupled to each other.

The simplest form of migration, aimed to relocate VNFs individually, refers as a simple VNF migration strategy. The simple VNF migration strategy may be limiting, since this strategy will only relocate the VNFs that are not coupled to their neighbor VNFs with stringent latency constraints. Moreover, given that the simple VNF migration aims to move a single VNF at a time, an additional transmission cost may be incurred, which can increase the resulting embedding cost.

Besides the simple VNF migration, another type of VNF migration can be realized by clustering a group of coupled VNFs and migrating them within a single physical node or across multiple physical nodes. This type of migration is referred to as cluster VNF migration, which can potentially reduce the embedding cost.

VNF migration has recently begun to receive attention. For example, migration decision-making based on Deep Reinforcement Learning has been proposed with the aim to solve the problem of service interruption caused by the excessive load of a single node, failure of links, and virtual function instances in the network. Online lazy-migration adaptive interference-aware (OLAIA) for virtual VNF deployment and migration in 5G network slicing has also been proposed. The main aim of OLAIA is to maximize the total reward of accepted requests in network slicing. The VNF scaling and migration problems, to meet the delay requirements in the presence of non-stationary traffic, have also been studied, with the use of a fractional Brownian motion (fBm) to learn the traffic model to predict time-varying VNF resource demand, and a deep Q-learning for dynamic VNF migration decisions was proposed. A migration algorithm, along with a prediction mechanism, was proposed to minimize transmission delay and migration time. A real-time VNF migration algorithm was proposed based on deep belief network to predict future resource requirements. Considering a scenario in which VNFs can be shared across multiple requests, a heuristic algorithm to migrate VNFs in a cost-effective manner to ease the burden of nodes and links has also been proposed with the objective to minimize the service cost and maximize the Quality-of-service (QoS). The VNF migration problem has been solved using a heuristic approach to minimize the Service Function Chain (SFC) delay and balance the network load. Some work focused on VNFs migration approaches which bring a solution to overloaded nodes and links. The VNF migration and service function chain (SFC) reconfiguration problem in data center networks, by considering VNF instances shared by multiple SFCs, was also studied. An Improved Hybrid Genetic Evolution (IHGE) algorithm was proposed to solve the problem, and a multi-stage heuristic algorithm was designed to reduce the computation overhead of the former algorithm, with the aim to minimize the end-to-end latency for all services and achieve network load balancing after migration.

The topic of VNF decomposition has been extensively studied. For example, the VNF placement problem, by considering function decomposition for virtual network service, has been studied. The problem was formulated as an Integer Linear Programming (ILP), and a heuristic solution was designed to solve the VNF placement problem by considering Function Decomposition (P-FD), with the objective to minimize the total cost of the substrate network. An optimization framework was presented for the decomposition and deployment of VNFs on a hybrid substrate network. The problem was formulated as mixed-integer linear optimization, with the aim to determine the best decomposition according to the traffic demands and the network topology. The joint optimization of service graph decomposition and embedding problems, was also studied and an ILP-based and mapping algorithms were proposed to minimize mapping cost; this was based on two segments: a decomposition selection with a backtracking phase and a mapping phase which leads to finding a suboptimal solution.

All the above-mentioned studies and proposals have focused either only on the VNF migration problem or only on the VNF decomposition and embedding problem.

### SUMMARY

In the real world, the VNF migration problem and the joint VNF decomposition and embedding problem are inter-related. For example, the selection of a migration plan has a great impact on the selection of the decomposition option. The selection of a decomposition option can greatly affect the QoS. Therefore, a solution is provided herein that considers the joint VNF decomposition and migration problem.

Most of the existing research studied the VNF migration problem under the assumption that one VNF instance is used by one VNF-FG. In such a case, the VNF migration process is easy to carry out, because only the VNF-FG that is closely related to the migrated VNF should be considered. In contrast, herein it is assumed that each deployed VNF may be used by different NSs. Thus, when migrating one VNF, all NSs traversing this VNF are taken into consideration, which is more practical. Moreover, most of the existing works on VNF migration aim to minimize the service daily and do not consider the VNF deployment cost.

In the solution provided herein, one objective is reducing the embedding cost, by taking a co-design approach and proposing a computationally efficient solution to solve the joint problem of VNF decomposition and migration, leveraging on various types of VNF migration including simple and cluster migration, among others. VNF topological decomposition and migration can be thought of as complementary and will reduce the VNF embedding cost for the service providers.

In the proposed solution, the VNF-FG embedding is optimized by jointly considering VNF decomposition and migration problems. This is done by jointly selecting the cost-efficient decomposition option and migrating already deployed VNFs to make room for the embedding of the selected decomposition option. Different migration schemes are considered, which consider migration of a single VNF or migration of a cluster of VNFs. The objective to minimize the embedding cost consists of minimizing transmission cost and fixed and variable capacity costs. The fixed capacity cost is attributed to the VNF capacity demands when they are newly instantiated, the variable capacity is considered when the workload is added/attached to a VNF, and transmission cost that attribute to the cost of bandwidth consumption for connection among VNFs.

Advantages include cost efficiency: the joint of VNF decomposition and migration can improve the total embedding cost of incoming requests (all NSs) by allowing the decision maker to handle the restricting impacts of the stringent inter-VNF latency constraints on VNF-FG embedding. Migration of VNFs from overloaded nodes and reusing more VNF instances of previous requests leads to efficient usage of network resources and consequently network can admit more incoming requests.

There is provided a computer implemented method for embedding a network service (NS) in a network comprising a plurality of nodes. The method comprises executing a first topological decomposition of the NS considering the network when loaded. The method comprises executing a second topological decomposition of the NS considering the network when unloaded. The method comprises migrating at least one existing virtual network function (VNF) that can be reused for the NS to another node of the network upon determination, based on comparing the first and second topological decompositions, that the at least one VNF needs to be migrated. The method comprises embedding each virtual network function (VNF) of the NS within the plurality of nodes of the network.

There is provided an apparatus operative to embed a network service (NS) in a network comprising a plurality of nodes. The apparatus comprises processing circuitry and a memory. The memory contains instructions executable by the processing circuitry whereby the apparatus is operative to execute a first topological decomposition of the NS considering the network when loaded. The apparatus is operative to execute a second topological decomposition of the NS considering the network when unloaded. The apparatus is operative to migrate at least one existing virtual network function (VNF) that can be reused for the NS to another node of the network upon determination, based on comparing the first and second topological decompositions, that the at least one VNF needs to be migrated. The apparatus is operative to embed each virtual network function (VNF) of the NS within the plurality of nodes of the network.

There is provided a non-transitory computer readable media having stored thereon instructions for embedding a network service (NS) in a network comprising a plurality of nodes. The instructions comprise executing a first topological decomposition of the NS considering the network when loaded. The instructions comprise executing a second topological decomposition of the NS considering the network when unloaded. The instructions comprise migrating at least one existing virtual network function (VNF) that can be reused for the NS to another node of the network upon determination, based on comparing the first and second topological decompositions, that the at least one VNF needs to be migrated. The instructions comprise embedding each virtual network function (VNF) of the NS within the plurality of nodes of the network.

The method and apparatus provided herein present improvements to the way VNF decomposition and migration operate.

### BRIEF DESCRIPTION OF THE DRAWINGS

FIG. 1a is a schematic illustration of a network topology with embedding for a network service NS1.

FIG. 1b is a schematic illustration of all possible decomposition options of all VNFs required by a network service NS2.

FIG. 1c is a schematic illustration of a tree graph showing all possible VNF-FGs for the network service NS2.

FIG. 1d is a schematic illustration of one possible VNF-FG (one possible topological decomposition of NS2).

FIG. 1e is a schematic illustration of an embedding of the best decomposition option without considering migration.

FIG. 1f is a schematic illustration of the migration of VNF J to Node2.

FIG. 1g is a schematic illustration of the embedding of the best decomposition option after the migration.

FIG. 2 is a flowchart of the proposed decomposition algorithm.

FIGS. 3a to 3d are schematic illustrations showing how the proposed ranking strategy is used to find potential candidate VNF-FGs for the network service NS2, where FIG. 3a shows the initialization of the source and destination node of a tree graph, FIG. 3b shows exploration of all decomposition options of VNF A and connection to source node, FIG. 3c shows the exploration of all decomposition option of VNF B and connection to O_{A,2} and FIG. 3d shows the exploration of all decomposition option of VNF C and connection to the destination node.

FIG. 4 is a flowchart of the proposed complete solution.

FIGS. 5a to 5c are schematic illustrations of the VNF FG of network services NS1, NS2 and NS3 respectively, according to an example.

FIGS. 5d to 5g are schematic illustrations of an example proposed migration strategy for a given VNF-FG for an unloaded network, where FIG. 5d shows the embedding of all VNF of NS1 and NS2 to the network, FIG. 5e shows the migration of the refine ignore list {X, J, L, Y, K} to Node 2 and the embedding of VNF F (reused) to Node1, FIG. 5f shows the migration of the refine ignore list {X} to Node 3 and the embedding of VNF K (reused) to Node 2 and FIG. 5g shows the embedding of VNF C to Node3.

FIG. 6 is a flowchart of a method for embedding a network service (NS) in a network comprising a plurality of nodes.

FIG. 7 is a schematic illustration of a hardware in which steps and method described herein can be executed.

FIG. 8 is a schematic illustration of a virtualization environment in which the different steps and hardware components described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

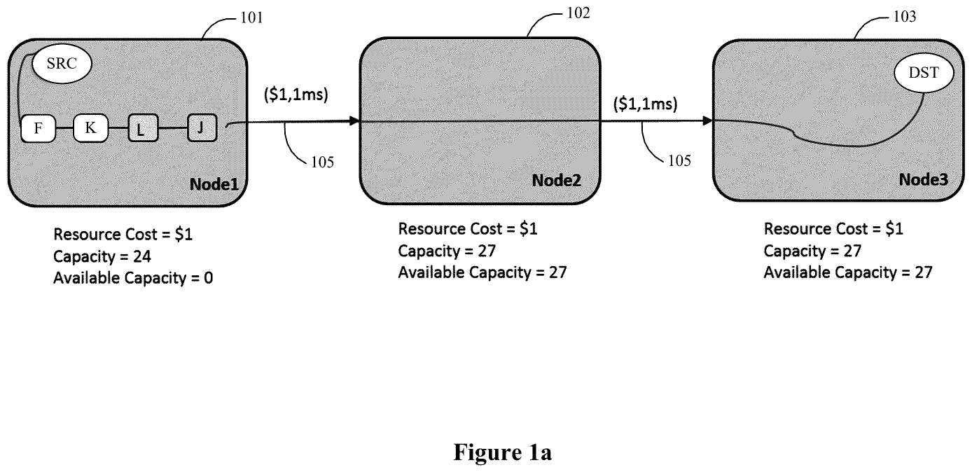

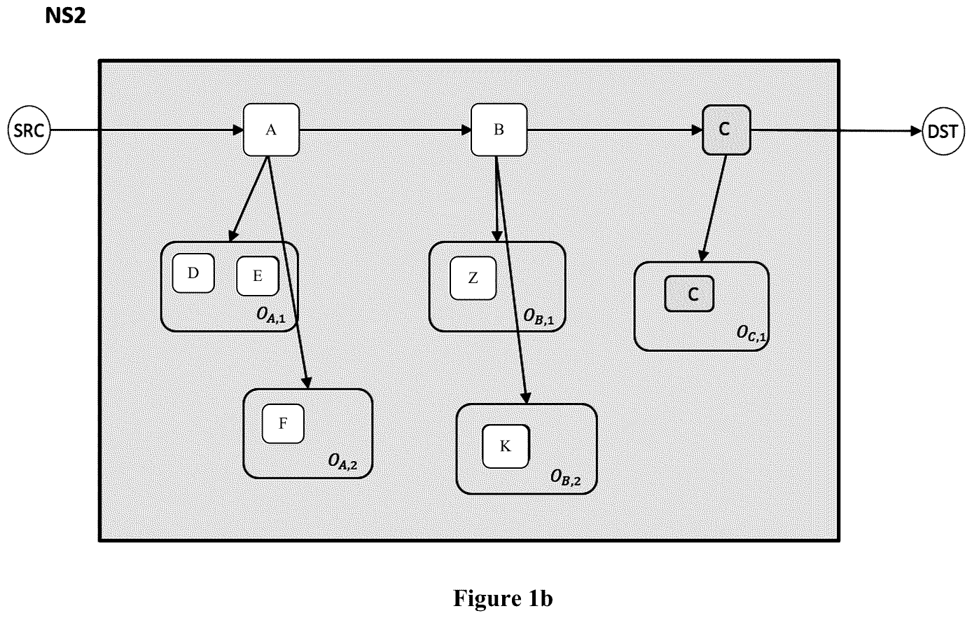

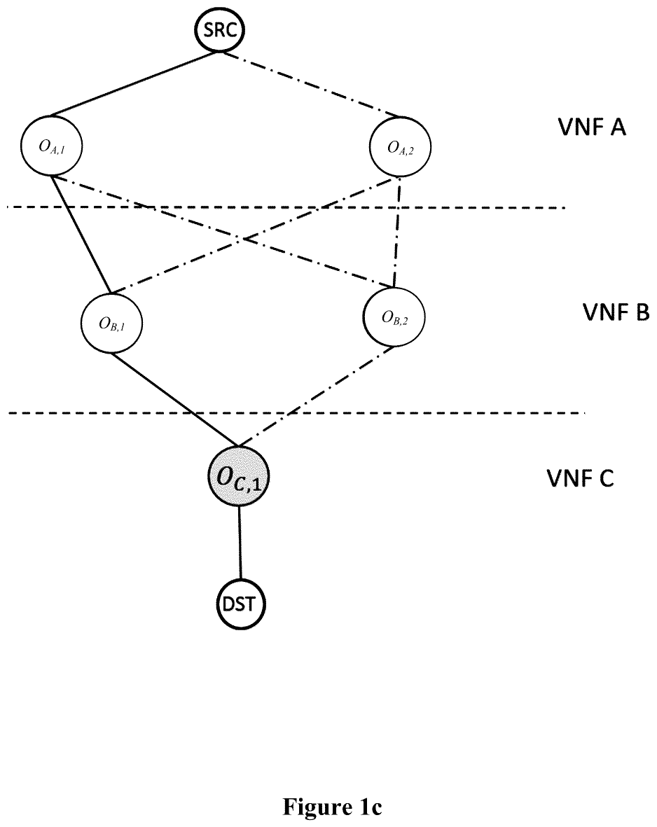

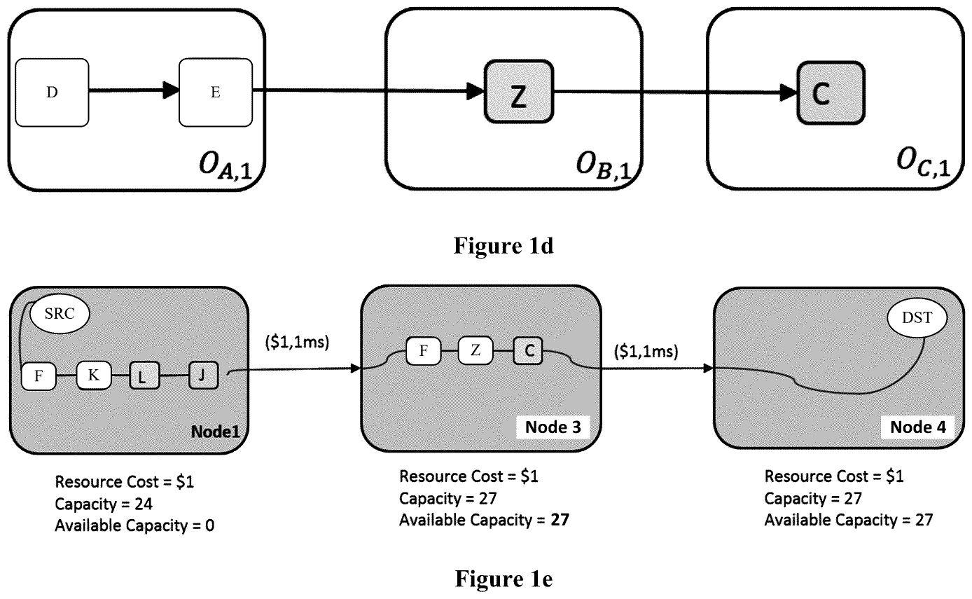

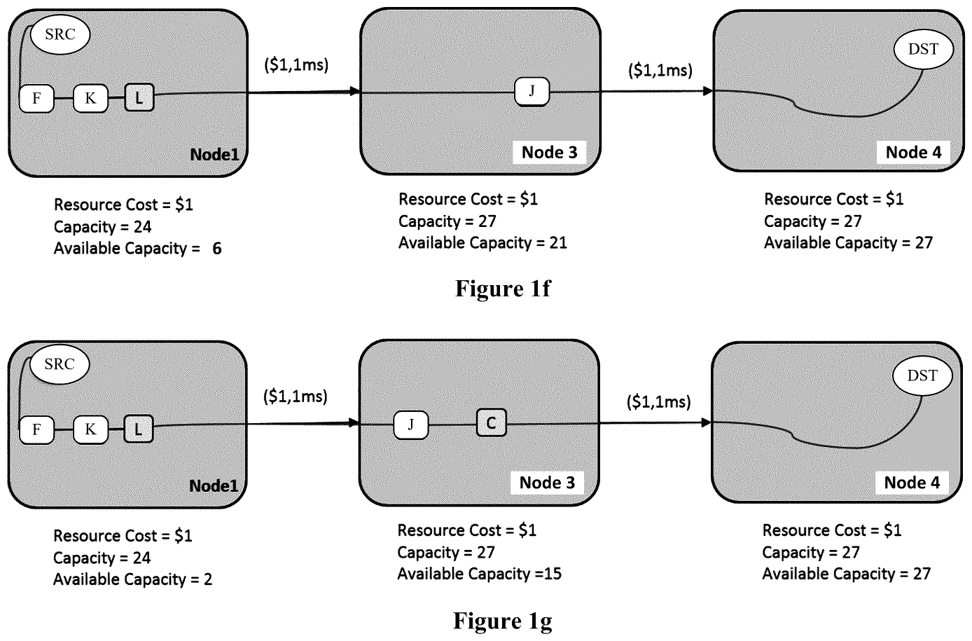

To better understand the problem to solve, let's demonstrate how migration can impact the selection of decomposition options and the quality of VNF-FG embedding solutions. First, let's consider a substrate network, comprising three physical nodes and two physical links, as shown in FIG. 1a. Each node (Node1 101, Node2 102, and Node3 103) is associated with node resource capacity, and cost per resource unit. For simplicity, let's assume all nodes support all VNF types. Similarly, each link 105 has a bandwidth capacity, cost per bandwidth unit, and link latency. Furthermore, each VNF type is associated with a predefined capacity demand that consists of fixed and variable capacities. The size of each VNF instance is fixed during runtime which means there is a need to allocate a fixed capacity, and whenever a workload is added to a VNF instance, that VNF needs a variable capacity. Therefore, once a VNF instance is newly instantiated, it is attributed with a fixed capacity and a variable capacity. When it is reused by another NS, the variable capacity is only considered while the fixed capacity is only added when it is instantiated. This means that a reused VNF needs the variable capacity demand and re-uses the fixed capacity demand of original VNF. For simplicity, it is assumed that the fixed capacity of all VNF types is 4 unit, and the variable capacity are 2 units, except for VNF type Z (FIG. 1b), for which it is assumed the fixed and variable capacity demand are 3 and 2, respectively.

Referring again to FIG. 1a, next, let's assume that NS 1 which consists of VNFs F, K, L and J is placed in Node 1. NS1 requires its traffic to be transmitted from Node1 as a source node and then processed by the VNF-FG (which is given in the form of an ordered set of VNFs) before reaching Node3 as a destination node. The capacity demand for NS1 is 24 units (4 VNF, each requiring 6 units of capacity). As all the VNFs on Node 1 are newly instantiated, they required fixed and variable capacity (e.g., the VNF F needs 4 units of fixed capacity and 2 units of variable capacity). Therefore, the available capacity of Node1 is 0.

Referring to FIG. 1b, now let's consider that NS2 requires the ordered set of VNFs, consisting of A, B, and C, and has one source and destination. Let's assume that the source is selected as Node 1 and the destination is selected as Node 3. Thus, the service provider must embed VNFs A, B, and C onto the substrate network and make sure that traffic of the NS2 is transmitted from the source to the destination while satisfying the given requirements. However, from an implementation point of view, each VNF can have one or multiple decomposition options, and each option can comprise one or multiple subfunctions as illustrated in FIG. 1b. For instance, VNF A has two decomposition options. Option 1 of VNF A (o_{A,1}) consists of two subfunctions (i.e., D and E), where o_{i,j}, is defined to indicate the decomposition option j of VNF i.

FIG. 1c shows a tree graph illustrating all connections of decomposition options between the VNFs for NS2, given that the source and destination are considered. As can be seen, NS2 has four decomposition realizations (O_{A,1 è} O_{B,1 è} O_{C,1}; O_{A,1 è} O_{B,2 è} O_{C,1}; O_{A,2 è} O_{B,1 è} O_{C,1}; O_{A,2 è} O_{B,2 è} O_{C,1}).

FIG. 1d demonstrates one possible VNF-FG of NS2 (topological decomposition) using the decomposition option 1 for each VNF A, B and C, from FIG. 1b.

In this example, however, it would be more cost-efficient to select a decomposition option that can reuse other VNFs in the network and that has a smaller number of sub-functions. The sub-functions F and K from NS2 can be reused as their instances are already deployed in Node 1 (see FIG. 1a). However, Node1 does not have enough capacity to serve any NS. Without considering any migration, the best decomposition option regarding the cost would be F, Z, and C. The VNF F and C require 4 fixed capacity and 2 variable capacity, and the VNF Z requires 3 fixed capacity and 2 variable capacity. By assuming the resource cost of Node 2 is 1$, the total resource cost of this VNF-FG would be 17$ (6$ for each of VNFs F and C, for fixed and variable capacity, and 5$ for VNF Z) and the link cost would be 2$. Therefore, the embedding cost would be 19$ (17$+2$) and the total embedding cost is $43 (as can be seen in FIG. 1e). VNFs F, K, L, J, F, C each cost 6$ (for fixed and variable capacity), VNF Z costs 5$ and both transmission links cost 1$ each, for a total of 43$.

However, by migrating VNF J to Node 2, as can be seen in FIG. 1f, the available capacity of Node 1 would be 6 units. Therefore, Node1 will have enough capacity to serve other NSs. VNF F and K on Node1 can be reused, and the best decomposition option becomes F, K, and C. The total embedding cost becomes 38$ for this VNF-FG (see FIG. 1g) i.e. (5*6$ per VNF F, K, L, J and C)+(2$ for the transmission cost for NS1)+(2$ for the transmission cost for NS2)+(2$ for the variable capacity cost for re-used VNF F)+(2$ for the variable capacity cost for re-used VNF K). By doing the migration of VNF J to Node 2, the total embedding cost is reduced by 5$. Therefore, an efficient strategy is still needed to select the best decomposition option by considering the migration of previous embedded VNFs to reduce the embedding cost.

### Proposed Solution

The solution consists of decomposition score calculation and ranking strategy to find decomposition options and migration strategy.

### Decomposition Score Calculation

The decomposition score (S_{d}) is designed to pre-evaluate combinations of decomposition options of VNFs to form a VNF-FG for a given NS, given that each VNF required by the NS can have one or multiple decompositions. This score is calculated based on the SP's objective. The main goal is to reduce the total embedding cost. Therefore, a scoring, based on the embedding cost, is defined. The total embedding cost consists of the transmission, fixed capacity, and variable capacity costs. As explained previously, each VNF has a fixed and variable capacity demand. The S_{d} includes the following score:
Link score (Sₗ) is defined as the cost of network bandwidth consumed for the communication between VNF instances.
Fixed score (S_{f}) is defined as the cost per capacity unit demand assigned to a new instantiation VNF. Once a VNF instance is newly instantiated, it attributes the fixed capacity demand.
Variable Score (Sᵥ) is defined as the cost per capacity unit assigned to a new or reused VNF instance. Each VNF, whether newly deployed or reused comprises a variable capacity demand. When additional workload is added to a VNF the variable capacity is considered.

The more instances of a VNF type are created, more fixed capacity is allocated across the network which leads to higher embedding cost. Consequently, S_{d} can be computed by:

$${S}_{d} = {S}_{l} + {S}_{f} + {S}_{v}$$

A person skilled in the art would understand that capacity can be allocated for the VNFs using different ratio of fixed vs variable capacity. Generally, the fixed capacity will be greater than the variable capacity.

### Ranking Strategy

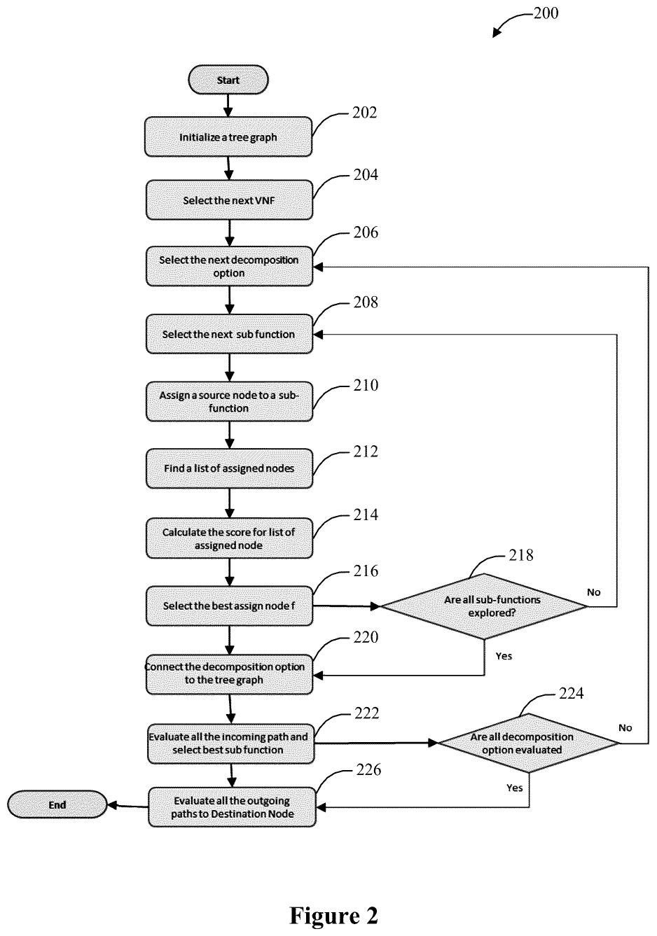

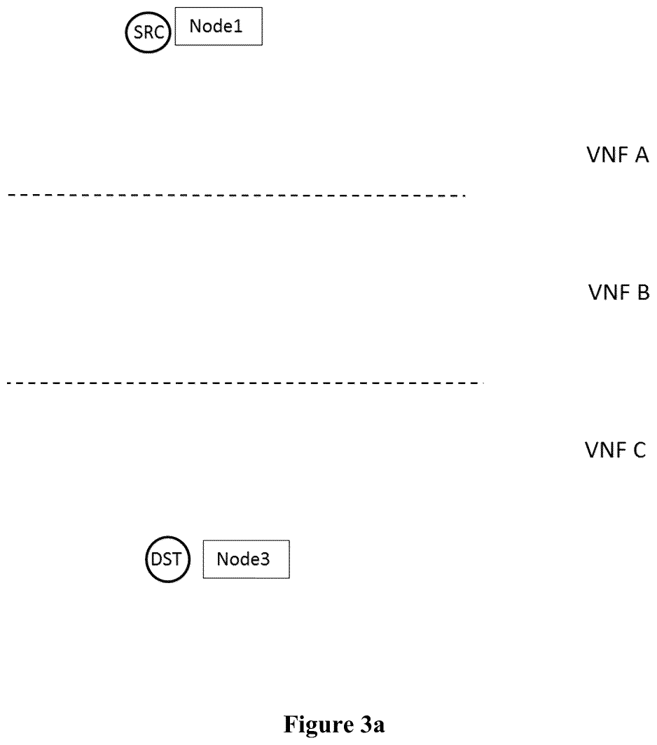

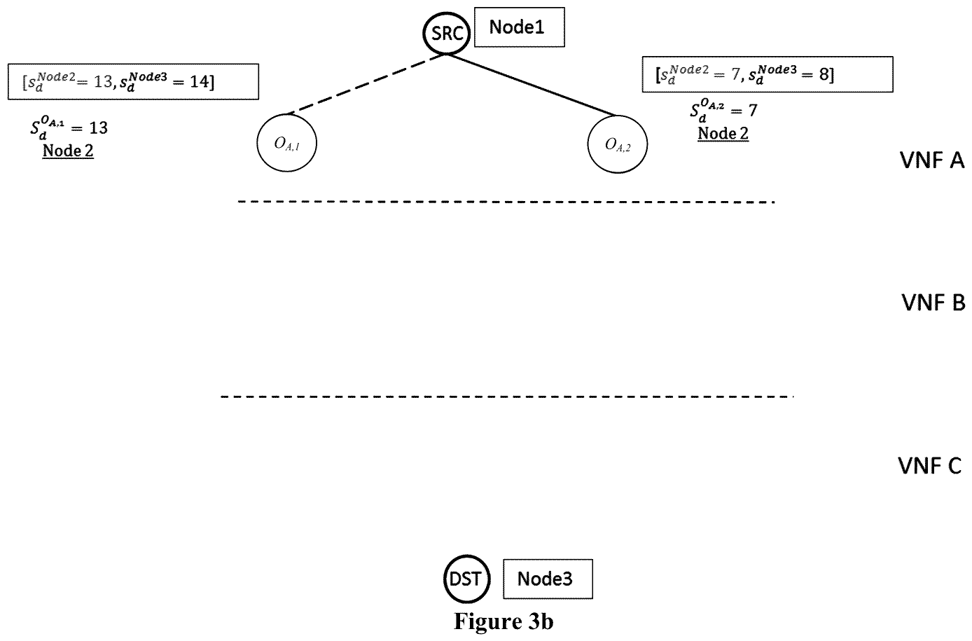

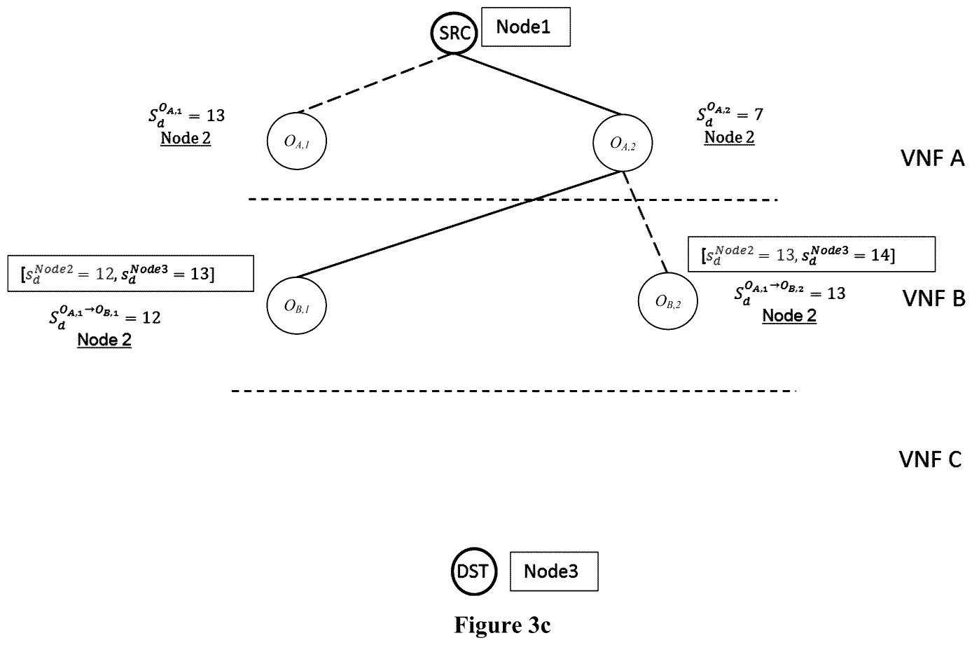

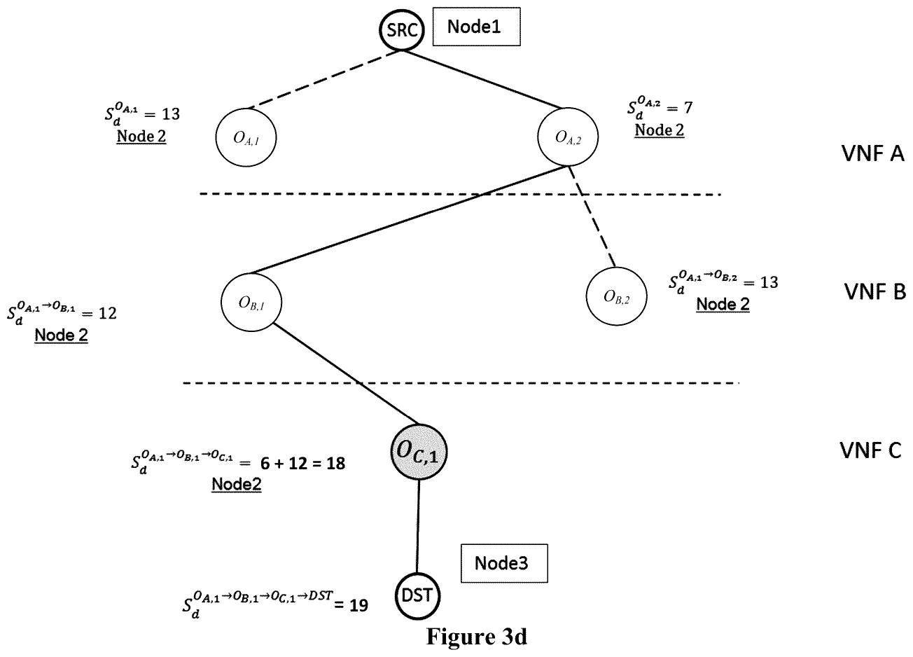

FIG. 2 is a flowchart of the proposed ranking strategy 200 for the decomposition. The ranking strategy works like a pre-evaluation before embedding a decomposition option in a network. To explore the decomposition options of VNFs in a service chain, the proposed ranking strategy starts by initializing a tree graph, step 202. For a given NS, the source-destination pair is assigned to a tree. The root node of the tree is associated with the source and the destination is the end of the tree. As an example, for FIG. 3a, Node1 is assigned as a source node, and Node 3 is assigned as the destination node of the tree. Next, for each VNF, all the related decomposition options are explored, starting with the first VNF, steps 204, 206 and 224. After that, all possible connections between the current decomposition option and the decomposition options of the previous VNF that were evaluated in the previous step in the tree graph are connected. If the given VNF is the first VNF in the service chain, the proposed ranking strategy connects the decomposition option of the given VNF to the source.

For each decomposition option, the algorithm explores all subfunctions, steps 208, 218 for a selected decomposition option and a substrate node is assigned to each explored subfunction. To do so, the algorithm first considers a source node for a related subfunction, step 210. The source for the first VNF's subfunctions is the source node of the tree (e.g., the source node for subfunction D in o_{A,1} is Node 1 in FIG. 1c), and the source node for other VNFs' subfunctions is the assigned node of a previously selected decomposition options/subfunction.

Second, the algorithm finds the best-assigned node to the current exploring subfunction. To find the best-assigned node to a sub-function, the algorithm finds a list of assigned nodes, step 212, that obeys the constraints (e.g., latency, support VNFs, and capacity) and calculates the scoring of the sub-function for each node in the list of assigned nodes, step 214. The best-assigned node is selected, step 216, from a list of assigned nodes that has a smaller score than the others.

After calculating a score for all sub-functions, the decomposition option score is calculated. The best-assigned node is assigned to a given decomposition option in which the best-assigned node is a node with a less value of the score among other nodes. For assigning the best-assigned node to the given decomposition option, the best-assigned node of the last sub-function of the current decomposition option is chosen as the best-assigned node, step 220. The proposed decomposition algorithm selects only one path (path between the current decomposition option and the previous decomposition option) that has a smaller score than others, step 222. Therefore, it eliminates all paths except the one that has the smaller decomposition score. Next, the proposed ranking strategy moves to the next decomposition option of the given VNF. This process is repeated for each VNF of the network service.

The destination node is explored after exploring all VNFs. The proposed ranking strategy connects the selected decomposition options of the last VNF to the destination and the algorithm calculates the score from the selected decomposition option and the destination node, step 226. Finally, a path from source to destination that has less score than others is selected.

### Example of the Proposed Ranking Strategy

To better understand how the proposed ranking strategy works, let's consider the network topology of FIG. 1a and NS2 in FIG. 1b. To find potential VNF-FGs the algorithm first initializes the source and destination nodes of a tree graph. In this example, it is assumed that Node 1 is the source node and Node 3 is the destination node, as shown in FIG. 3a.

Then, the decomposition options of the first VNF (i.e., VNF A) are explored. The first decomposition option (i.e., o_{A,1}) of VNF A is evaluated by exploring all possible connections between o_{A,1} and the source and connecting them together. Then, for each sub-function of a decomposition option, a list of the assigned nodes is found and the S_{d} is calculated.

Let's now consider o_{A,1} which consists of sub-function D and E. For each sub-function of the decomposition option of o_{A,1}, the S_{d} is calculated and a node is assigned to a sub-function. First, a list of assigned nodes for subfunction D is found. A list of assigned nodes is a list of all nodes that obey the constraint such as support for that VNF type, satisfying latency constraint, having enough capacity, etc. The list of assigned nodes for sub-function D is Node 2 and Node 3. Since Node 1, did not have enough capacity, it was not selected as an assigned node. After that, S_{d} for each node in the list of assigned nodes is calculated. For sub-function D,

$${S}_{d}^{{Node}_{2}} = 7$$

as Sₗ=1, S_{f}=4 and Sᵥ=2. The algorithm selects the node with the smallest amount of S_{d} as the best-assigned node for a subfunction. For subfunction D Node 2 has a smaller value of S_{d} than Node 3, as the Sₗ=2 for Node 3. Therefore, Node 2 is selected as an assigned node for the subfunction D. Then, this process continues for all the sub-function of a decomposition option. The process continues for subfunction E, the assigned node and S_{d} are calculated for subfunction E. The S_{d} for a decomposition option is the summation of S_{d} for all subfunctions. The S_{d} for O_{A,1}, is the sum of the S_{d} for sub-functions E and D. The S_{d} for subfunction E is 6. Therefore, S_{d}=13 for o_{A,1}. The last subfunction's assigned node is considered as an assigned node of the decomposition option. In this case, for sub-function E, the assigned node is Node 2, then Node 2 is considered as an assigned node for o_{A,1}.

This process will continue for the remaining decomposition options of VNF A. In this scenario, for O_{A,2} the algorithm finds a list of assigned nodes and selects the best node with a smaller amount of S_{d} (see FIG. 3b).

As shown in FIGS. 3c and 3d, this process continues for the remaining VNFs of NS2. For all the decomposition options of VNF B the source node is updated to Node 2 as the previously decomposition option assigned node is Node2. This process continues until the last VNF. After that, all the connections to the destination node are considered and the S_{d} is calculated for the connection of a last subfunction to a destination node (see FIG. 3d). Finally, a path from source to destination that has a score smaller than others is selected.

### Migration Strategy and the Proposed Solution

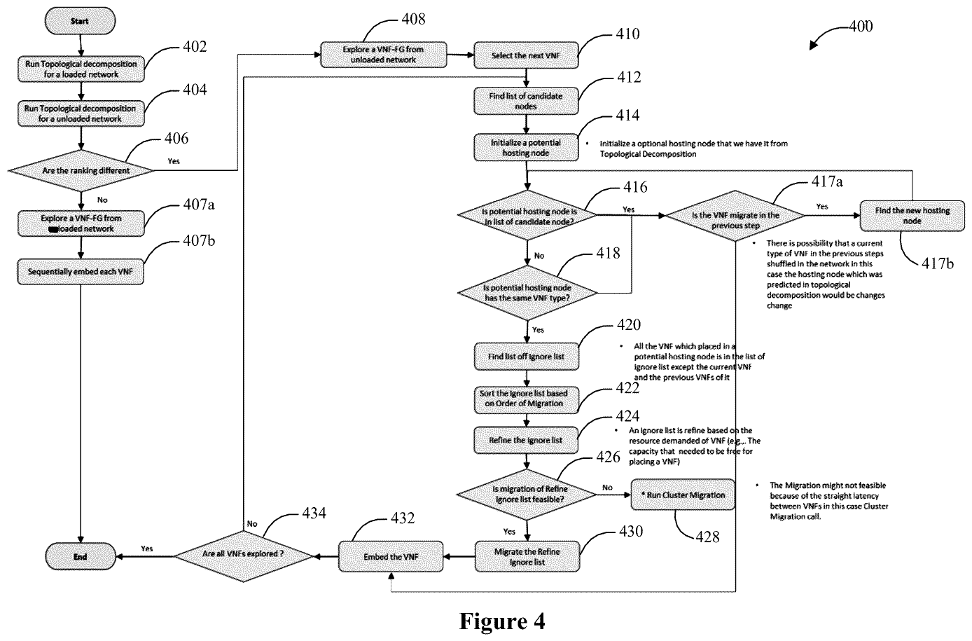

FIG. 4 presents a flowchart of the proposed solution 400 with details on how the proposed migration algorithm works. Using the algorithm presented in FIG. 2, first, the topological decomposition runs for a loaded network, step 402; then, the topological decomposition runs for an unloaded network, step 404.

Herein, a “loaded network” is defined as a network in its current state with the load being the total load being carried by each node of the network. An “unloaded network” is defined as a network when it is empty and there is no load in the nodes of the network. Thus, in the unloaded network, the nodes have enough capacity to embed the VNFs.

By doing this, two VNF-FG are obtained with their own ranking score and their assigned hosting nodes for each VNF. If the score from unloaded network is greater or equal to the loaded network, step 406, the VNFs of VNF-FG, obtained from the proposed decomposition algorithm when the network is loaded, are embedded in the network sequentially, steps 407a and 407b. Otherwise, migration might be needed to evict some previously deployed VNFs.

For doing the migration, for each VNF, steps 408 and 410, the algorithm finds a list of candidate nodes, step 412, and if the assigned hosting node (the assigned hosting node designated to each VNF after running the decomposition algorithm) is not in the list of candidate nodes, step 416, and the same VNF type is hosted in the assigned hosting node, step 418, it means the assigned node does not have enough capacity and because of that it is not included in a list of candidate node. In the case where the VNF was migrated in a previous step, step 417a, the new hosting node is located, step 417b, and the process resumes.

Then the algorithm finds a list of ignore lists, step 420, which is a list of potential VNFs that can be migrated to other nodes. The ignore list consists of all the embedded VNFs placed on the assigned hosting nodes except the current VNF and the previous VNFs of it.

After that, the algorithm sorts the ignore list based on the order of migration, step 422. The order of migration starts from the last NS and VNF which is embedded in the assigned node and continues the contrary order of embedding of VNFs on the assigned Node. If a VNF is re-used by more than one NS in the ignore list, all the subsequent VNFs of NSs that reused that type of VNF is checked and the algorithm should start from the last VNF of that NS which is in the ignore list. This process continues until all the VNFs of the ignore list are sorted.

After that, the algorithm refines the sorted ignore list, step 424, based on the capacity demand of the current VNF. The refine ignore list includes a VNF or multiple VNFs based on the capacity demand for a VNF.

After finding a refined ignore list, the possibility to migrate the refined ignore list to a new node is checked, step 426. Because of the stringent latency between VNFs, it might not be possible to migrate the VNFs of the refined ignore list. In this case, Cluster Migration would happen, step 428, which is explained further below. Otherwise, the VNFs in the refined ignore list is evicted from the assigned node to a new node, step 430, and a current VNF is embedded into an evicted node. By doing the migration, the network situation would be changed and the assigned node that was predicted for each VNF in the topological decomposition algorithm does not always host a specific VNF type as predicted. As explained previously, to handle this, for a VNF there is a check whether that type of VNF in the previous steps is migrated or not, step 417a, and if it changes the location, a location is found after migration, step 417b, and the hosted node for the current VNF is updated.

Once this is done, the VNF is embedded, step 432, and a check is made regarding if all the VNFs have been explored, step 434. Once all VNFs are explored, the process ends.

### Example of the Proposed Migration Strategy

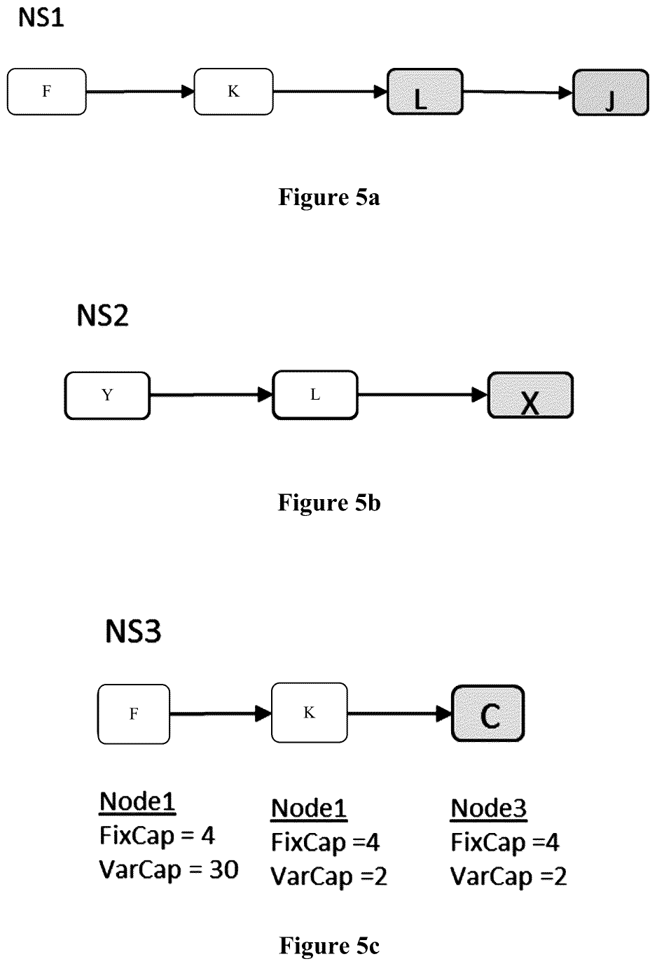

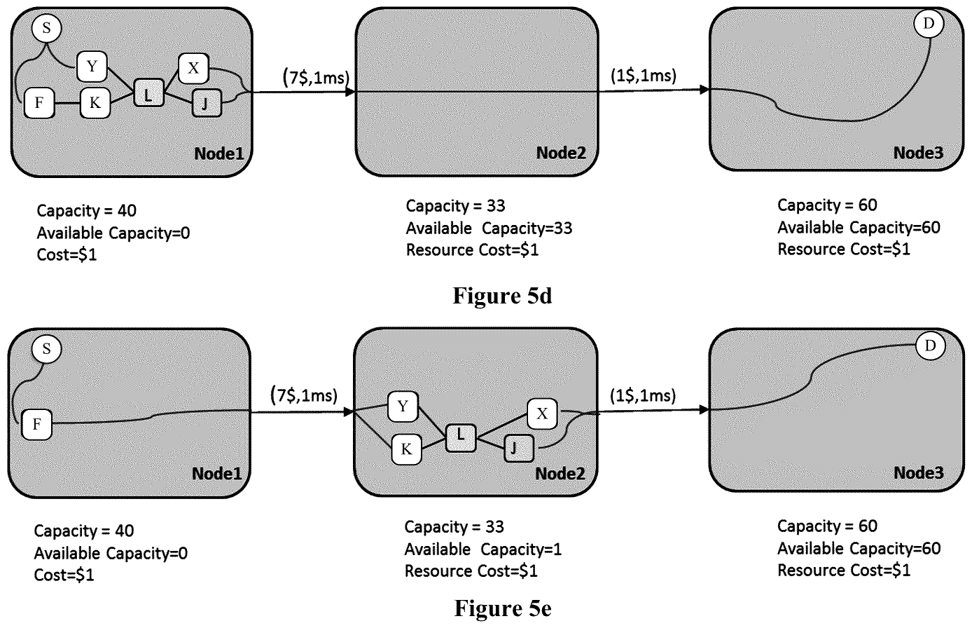

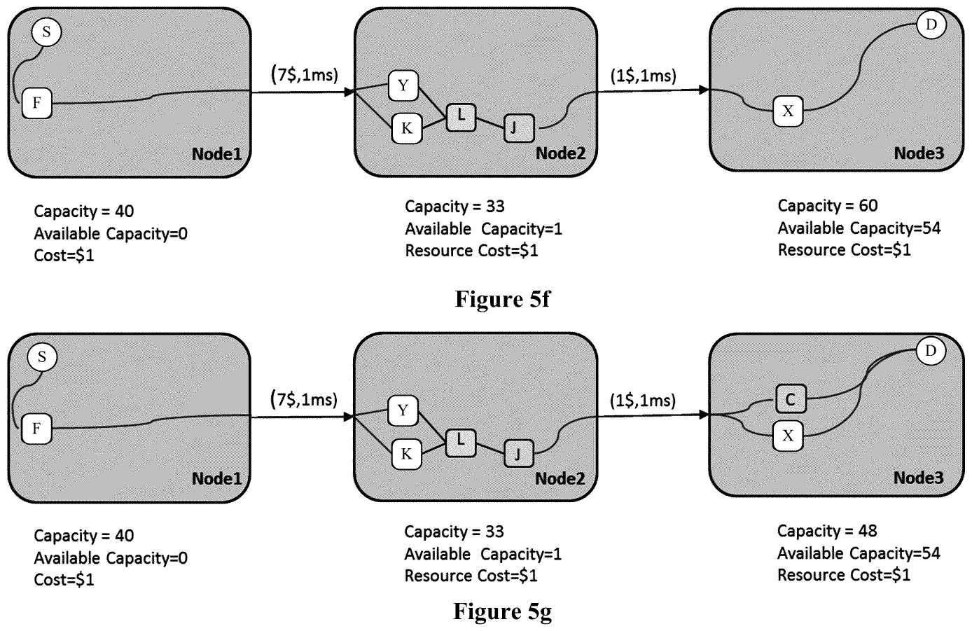

Turning to FIGS. 5a to 5g, to better understand how the proposed ranking strategy works, let's consider NS 1, NS 2, and NS 3 as shown in FIG. 5a, FIG. 5b and FIG. 5c respectively. It is assumed that NS1 and NS2 are already deployed in the network as can be seen when looking at FIG. 5d, in which Node1 comprises all the VNFs of NS1 and NS2.

Let's assume NS3 is a given VNF-FG from a topological decomposition when the network is unloaded. The assigned node for each VNF of NS3 is also shown in FIG. 5c, under each VNF. As an example, the assigned node for VNF K of NS 3 is Node 1. The capacity demand of VNFs of NS3 is also shown in FIG. 5c. As an example, VNF F requires 4 fixed capacity and 18 variable capacity for NS3.

In this example, it is assumed the score of VNF-FG of the unloaded network is less than the loaded network. In this case, the migration is done.

Referring to FIGS. 5a to 5d, let's assume all the VNF types of NS1 and NS2 require 4 fixed and 2 variable capacities. The algorithm starts with the first VNF of NS3 which is VNF F. First, the algorithm finds a list of candidate nodes for VNF F. The list of candidate nodes for VNF F is Node 2 and Node 3. As Node 1 does not have enough capacity (as shown on FIG. 5d) it cannot be part of the list of candidate nodes. After that, a check is made whether the assigned node, which is Node 1 is part of the list of candidate nodes or not. Then a check is made whether Node 1 has the VNF type F or not. As these two conditions are met. The algorithm creates an ignore list for VNF F. The ignore list includes all the VNF residing in Node 1 except the VNF type F. Therefore, the ignore list for VNF F includes a list of [X, Y, L, J, K]. After that, the ignore list is sorted based on the order of migration. The last NS which is embedded in Node 1 is NS2 and the last VNF of NS2 is VNF X. X is added to the sorted ignore list.

After that, the VNF previous to X is L. As VNF L is already reused by NS1, before adding L to the sorted ignore list all the VNFs after VNF L in NS1 are added, starting from the last VNF. The last VNF in NS1 is VNF J. Therefore, VNF J is added to the sorted ignore list. Then VNF L is added to the sorted ignore list and after that VNF Y from NS2 and finally, VNF K from NS1 is added to the sorted ignore list. The sorted ignore list for VNF F of NS3 is an order list of X, J, L, Y, and K.

Then, the sorted ignore list is refined based on the capacity demand of VNF F. The variable capacity demand of VNF F is 30, as indicated in FIG. 5c, so the refine ignore list includes [X, J, L, Y]. Next, all the VNFs of the ignore list are migrated to Node 2 and VNF F is also embedded in Node 1 (see FIG. 5e).

The next VNF of NS3, after VNF F, is VNF K. The assigned node for VNF K is Node 1 but VNF K in the previous step was migrated to Node 2. In this case, Node 2 is considered as an assigned Node for K and a list of candidate Node for K is found. In this example, the list of candidate nodes for K is Node 3 and because there is a VNF type K in Node 2 and Node 2 does not have enough capacity to serve VNF K, to be able to embed VNF K of NS2 to Node 2, the ignore list for VNF K is created. The ignore list for VNF K includes all the VNFs that are placed on Node 2 except the same VNF type which is (X, L, Y and J). The sorted ignore list for VNF K is X, J, L, and Y.

After that, based on the capacity demand of VNF type K, the sorted ignore list is refined. The variable capacity of VNF K in NS 3 is 2 so the refined ignore list includes VNF X. The VNF X is migrated to Node 3 and the next VNF K is placed in Node 2 (see FIG. 5f). This process continues for the other VNFs of NS 3 until all the VNFs are embedded in the network (see FIG. 5g).

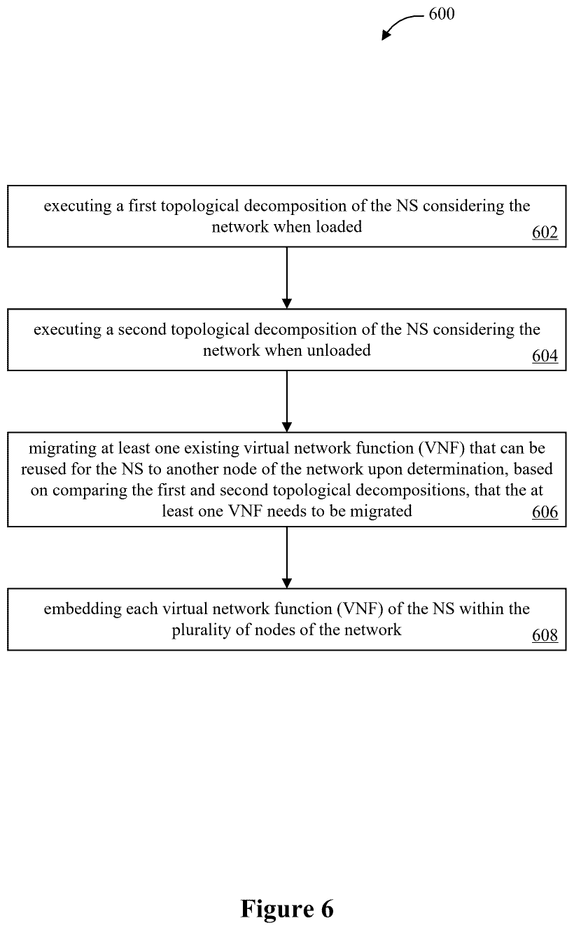

Turning to FIG. 6, there is provided a computer implemented method 600 for embedding a network service (NS) in a network comprising a plurality of nodes. The method comprises executing, step 602, a first topological decomposition of the NS considering the network when loaded. The method comprises executing, step 604, a second topological decomposition of the NS considering the network when unloaded. The method comprises migrating, step 606, at least one existing virtual network function (VNF) that can be reused for the NS to another node of the network upon determination, based on comparing the first and second topological decompositions, that the at least one VNF needs to be migrated. The method comprises embedding, step 608, each virtual network function (VNF) of the NS within the plurality of nodes of the network.

Executing a topological decomposition may comprise building a tree graph comprising all connections of decomposition options for VNFs and subfunctions of the VNFs of the NS and identifying all possible decomposition realizations. Executing the topological decomposition may further comprise computing a decomposition score S_{d} for comparing all the possible decomposition realizations, and may further comprise selecting the decomposition realization having a smallest decomposition score S_{d}. The decomposition score S_{d} may be a sum of a link score Sₗ, a fixed score S_{f} and a variable score Sᵥ. Computing the decomposition score S_{d} for all the possible decomposition realizations may comprise assigning a source node to a subfunction, finding a list of nodes to which the subfunction can be assigned and computing the decomposition score for each node of the list of nodes to which the subfunction can be assigned.

Comparing all the possible decomposition realizations may comprise comparing the decomposition score for each node of the list of assigned nodes, for each subfunction, and may comprise selecting a node, to which each subfunction can be assigned, having the smallest decomposition score. The first topological decomposition and the second topological decomposition may be executed according to the method described above.

The determination, based on comparing the first and second topological decompositions, that the at least one VNF needs to be migrated, may comprise comparing a first decomposition score S_{d} obtained for the first topological decomposition by selecting a decomposition realization having a smallest decomposition score S_{d} among a plurality of decomposition realizations for the first topological decomposition, with a second decomposition score S_{d} obtained for the second topological decomposition by selecting a decomposition realization having the smallest decomposition score S_{d} among a plurality of decomposition realizations for the second topological decomposition, and determining that the first decomposition score is different from the second decomposition score.

Each VNF may be attributed a fixed capacity and a variable capacity. Each node of the plurality of nodes may be associated with a node resource capacity and a charge per resource unit and each link between first and second nodes may be associated with a bandwidth capacity, charge per bandwidth unit, and link latency.

Migrating at least one existing VNF that can be reused for the NS to another node of the network may comprise identifying a list of candidate nodes for the VNF, initializing a hosting node identified by the second topological decomposition for the VNF, and upon determining that the hosting node is not in the list of candidate nodes and upon determining that the hosting node comprises a VNF of a same type as the at least one existing VNF, identifying a list of VNFs that can be migrated to other nodes, based on a capacity demand of the VNF exceeding a capacity of the hosting node, and migrating the at least one existing VNF.

Embedding each virtual network function (VNF) of the NS within the plurality of nodes of the network may further comprise instantiating each VNF.

It should be noted that methods and steps described herein are, generally, computer implemented methods and steps. The term computer may be interpreted as having different meanings, such as explained next, for example.

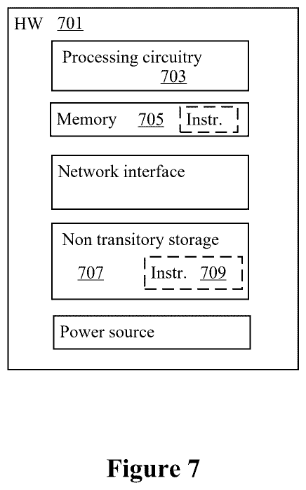

Referring to FIG. 7, there is provided an apparatus (HW) 701, in which functions and steps described herein can be implemented.

The apparatus 701 may be a server, network node, radio base station, or other computing device which may be part of a cloud computing system, edge computing system, or which may be a standalone device.

The apparatus 701 may be used for embedding a network service in a node of a network, and to execute all the steps described previously. The apparatus 701 may be used to achieve joint decomposition and migration of VNFs in a cost-efficient manner.

The apparatus 701 comprises processing circuitry 703 and memory 705. The memory 705 can contain instructions executable by the processing circuitry 703 whereby functions and steps described herein may be executed to provide any of the relevant features and benefits disclosed herein.

The apparatus 701 may also include non-transitory, persistent, machine-readable storage media 707 having stored therein software and/or instruction 709 executable by the processing circuitry 703 to execute functions and steps described herein. The apparatus may also include network interface(s) and a power source.

The instructions 709 may include a computer program for configuring the processing circuitry 703. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

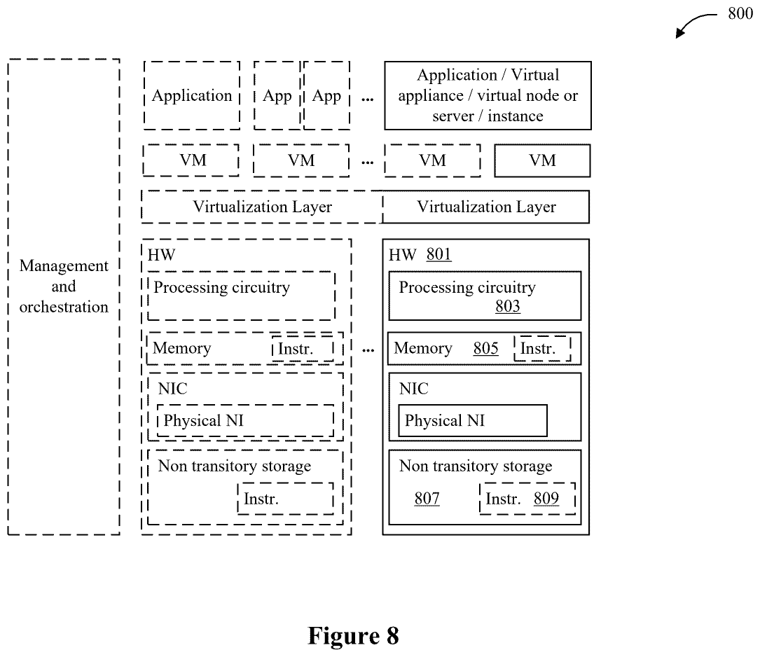

Referring to FIG. 8, there is provided a virtualization environment 800 in which functions and steps described herein can be implemented.

The virtualization environment 800 (which may go beyond what is illustrated in FIG. 8), may comprise systems, networks, servers, nodes, devices, etc., that are in communication with each other either through wire or wirelessly, e.g., through a network interface component (NIC) comprising physical network interface(s). Some or all of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 801 comprising processing circuitry 803 and memory 805. The memory 805 can contain instructions executable by the processing circuitry 803 whereby functions and steps described herein may be executed to provide any of the relevant features and benefits disclosed herein.

The hardware 801 may also include non-transitory, persistent, machine-readable storage media 807 having stored therein software and/or instruction 809 executable by the processing circuitry 803 to execute functions and steps described herein.

The instructions 809 may include a computer program for configuring the processing circuitry 803. The computer program may be stored in a removable memory, such as a portable compact disc, portable digital video disc, or other removable media. The computer program may be stored in a physical memory local to the hardware 801, which can be removable, or it could alternatively, or in part, be stored in the cloud. The computer program may also be embodied in a carrier such as an electronic signal, optical signal, radio signal, or computer readable storage medium.

Referring again to FIGS. 7 and 8, there is provided an apparatus 701, 801 operative to embed a network service (NS) in a network comprising a plurality of nodes. The apparatus 701, 801 comprises processing circuitry 703, 803 and a memory 705, 805. The memory 705, 805 contains instructions executable by the processing circuitry 703, 803 whereby the apparatus 701, 801 is operative to execute a first topological decomposition of the NS considering the network when loaded. The apparatus is operative to execute a second topological decomposition of the NS considering the network when unloaded. The apparatus is operative to migrate at least one existing virtual network function (VNF) that can be reused for the NS to another node of the network upon determination, based on comparing the first and second topological decompositions, that the at least one VNF needs to be migrated. The apparatus is operative to embed each virtual network function (VNF) of the NS within the plurality of nodes of the network.

The apparatus is operative to build a tree graph comprising all connections of decomposition options for VNFs and subfunctions of the VNFs of the NS and identify all possible decomposition realizations. The apparatus is operative to compute a decomposition score S_{d} for comparing all the possible decomposition realizations, and select the decomposition realization having a smallest decomposition score S_{d}. The decomposition score S_{d} is a sum of a link score Sₗ, a fixed score S_{f} and a variable score Sᵥ. The apparatus is operative to assign a source node to a subfunction, find a list of nodes to which the subfunction can be assigned and compute the decomposition score for each node of the list of nodes to which the subfunction can be assigned.

The apparatus is operative to compare the decomposition score for each node of the list of assigned nodes, for each subfunction, and select a node, to which each subfunction can be assigned, having the smallest decomposition score. The apparatus is operative to execute the first topological decomposition and the second topological decomposition according to the method described previously.

The apparatus is operative to compare a first decomposition score S_{d} obtained for the first topological decomposition by selecting a decomposition realization having a smallest decomposition score S_{d} among a plurality of decomposition realizations for the first topological decomposition, with a second decomposition score S_{d} obtained for the second topological decomposition by selecting a decomposition realization having the smallest decomposition score S_{d} among a plurality of decomposition realizations for the second topological decomposition, and determine that the first decomposition score is different from the second decomposition score.

Each VNF may be attributed a fixed capacity and a variable capacity. Each node of the plurality of nodes may be associated with a node resource capacity and a charge per resource unit and each link between first and second nodes may be associated with a bandwidth capacity, charge per bandwidth unit, and link latency.

The apparatus is operative to identify a list of candidate nodes for the VNF, initialize a hosting node identified by the second topological decomposition for the VNF, and upon determining that the hosting node is not in the list of candidate nodes and upon determining that the hosting node comprises a VNF of a same type as the at least one existing VNF, identify a list of VNFs that can be migrated to other nodes, based on a capacity demand of the VNF exceeding a capacity of the hosting node, and migrate the at least one existing VNF.

The apparatus is further operative to instantiate each VNF.

Still referring to FIGS. 7 and 8, there is provided a non-transitory computer readable media 707, 807 having stored thereon instructions 709, 809 for embedding a network service (NS) in a network comprising a plurality of nodes. The instructions comprise executing a first topological decomposition of the NS considering the network when loaded. The instructions comprise executing a second topological decomposition of the NS considering the network when unloaded. The instructions comprise migrating at least one existing virtual network function (VNF) that can be reused for the NS to another node of the network upon determination, based on comparing the first and second topological decompositions, that the at least one VNF needs to be migrated. The instructions comprise embedding each virtual network function (VNF) of the NS within the plurality of nodes of the network.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A computer implemented method for embedding a network service (NS) in a network comprising a plurality of nodes, the method comprising:
executing a first topological decomposition of the NS considering the network when loaded;
executing a second topological decomposition of the NS considering the network when unloaded;
migrating at least one existing virtual network function (VNF) that can be reused for the NS to another node of the network upon determination, based on comparing the first and second topological decompositions, that the at least one VNF needs to be migrated; and
embedding each virtual network function (VNF) of the NS within the plurality of nodes of the network.

2. The method of claim 1, wherein executing a topological decomposition comprises building a tree graph comprising all connections of decomposition options for VNFs and subfunctions of the VNFs of the NS and identifying all possible decomposition realizations.

3. The method of claim 2, wherein executing the topological decomposition further comprises computing a decomposition score S_{d} for comparing all the possible decomposition realizations, and further comprising selecting the decomposition realization having a smallest decomposition score S_{d}.

4. The method of claim 3, wherein the decomposition score S_{d} is a sum of a link score Sₗ, a fixed score S_{f} and a variable score Sᵥ.

5. The method of claim 3, wherein computing the decomposition score S_{d} for all the possible decomposition realizations comprises assigning a source node to a subfunction, finding a list of nodes to which the subfunction can be assigned and computing the decomposition score for each node of the list of nodes to which the subfunction can be assigned.

6. The method of claim 5, wherein comparing all the possible decomposition realizations comprises comparing the decomposition score for each node of the list of assigned nodes, for each subfunction, and comprises selecting a node, to which each subfunction can be assigned, having the smallest decomposition score.

7. (canceled)

8. The method of claim 1, wherein the determination, based on comparing the first and second topological decompositions, that the at least one VNF needs to be migrated, comprises comparing a first decomposition score S_{d} obtained for the first topological decomposition by selecting a decomposition realization having a smallest decomposition score S_{d} among a plurality of decomposition realizations for the first topological decomposition, with a second decomposition score S_{d} obtained for the second topological decomposition by selecting a decomposition realization having the smallest decomposition score S_{d} among a plurality of decomposition realizations for the second topological decomposition, and determining that the first decomposition score is different from the second decomposition score.

9. The method of claim 1, wherein each VNF is attributed a fixed capacity and a variable capacity.

10. The method of claim 1, wherein each node of the plurality of nodes is associated with a node resource capacity and a charge per resource unit and wherein each link between first and second nodes is associated with a bandwidth capacity, charge per bandwidth unit, and link latency.

11. The method of claim 1, wherein migrating at least one existing VNF that can be reused for the NS to another node of the network comprises:
identifying a list of candidate nodes for the VNF;
initializing a hosting node identified by the second topological decomposition for the VNF; and
upon determining that the hosting node is not in the list of candidate nodes and upon determining that the hosting node comprises a VNF of a same type as the at least one existing VNF, identifying a list of VNFs that can be migrated to other nodes, based on a capacity demand of the VNF exceeding a capacity of the hosting node, and migrating the at least one existing VNF.

12. The method of claim 1, wherein embedding each virtual network function (VNF) of the NS within the plurality of nodes of the network further comprises instantiating each VNF.

13. An apparatus operative to embed a network service (NS) in a network comprising a plurality of nodes, the apparatus comprising processing circuitry and a memory, the memory containing instructions executable by the processing circuitry whereby the apparatus is operative to:
execute a first topological decomposition of the NS considering the network when loaded;
execute a second topological decomposition of the NS considering the network when unloaded;
migrate at least one existing virtual network function (VNF) that can be reused for the NS to another node of the network upon determination, based on comparing the first and second topological decompositions, that the at least one VNF needs to be migrated; and
embed each virtual network function (VNF) of the NS within the plurality of nodes of the network.

14. The apparatus of claim 13, further operative to build a tree graph comprising all connections of decomposition options for VNFs and subfunctions of the VNFs of the NS and identify all possible decomposition realizations.

15. The apparatus of claim 14, further operative to compute a decomposition score S_{d} for comparing all the possible decomposition realizations, and select the decomposition realization having a smallest decomposition score S_{d}.

16-19. (canceled)

20. The apparatus of claim 13, further operative to compare a first decomposition score S_{d} obtained for the first topological decomposition by selecting a decomposition realization having a smallest decomposition score S_{d} among a plurality of decomposition realizations for the first topological decomposition, with a second decomposition score S_{d} obtained for the second topological decomposition by selecting a decomposition realization having the smallest decomposition score S_{d} among a plurality of decomposition realizations for the second topological decomposition, and determine that the first decomposition score is different from the second decomposition score.

21. The apparatus of claim 13, wherein each VNF is attributed a fixed capacity and a variable capacity.

22. The apparatus of claim 13, wherein each node of the plurality of nodes is associated with a node resource capacity and a charge per resource unit and wherein each link between first and second nodes is associated with a bandwidth capacity, charge per bandwidth unit, and link latency.

23. The apparatus of claim 13 further operative to:
identify a list of candidate nodes for the VNF;
initialize a hosting node identified by the second topological decomposition for the VNF; and
upon determining that the hosting node is not in the list of candidate nodes and upon determining that the hosting node comprises a VNF of a same type as the at least one existing VNF, identify a list of VNFs that can be migrated to other nodes, based on a capacity demand of the VNF exceeding a capacity of the hosting node, and migrate the at least one existing VNF.

24. The apparatus of claim 13, further operative to instantiate each VNF.

25. A non-transitory computer readable media having stored thereon instructions for embedding a network service (NS) in a network comprising a plurality of nodes, the instructions comprising:
executing a first topological decomposition of the NS considering the network when loaded;
executing a second topological decomposition of the NS considering the network when unloaded;
migrating at least one existing virtual network function (VNF) that can be reused for the NS to another node of the network upon determination, based on comparing the first and second topological decompositions, that the at least one VNF needs to be migrated; and
embedding each virtual network function (VNF) of the NS within the plurality of nodes of the network.
